(19) United States
(12) Patent Application Publication
(10) Pub. No.: US 2004/0201283 A1
(43) Pub. Date: Oct. 14, 2004

(54) Parallel power supply system and control method thereof

(75) Inventors: Fu-Sheng Pai, Tainan (TW); Shiuann Jang Chiang, Tainan (TW); Wen-Yin Tasi, Yungkang City (TW)

Correspondence Address: HAVERSTOCK & OWENS LLP, 162 NORTH WOLFE ROAD, SUNNYVALE, CA, 94086, US

(73) Assignee: Delta Electronics, Inc.

(21) Appl. No.: 10/411,643

(22) Filed: Apr. 10, 2003

(51) Int. Cl. H02J 1/00

(52) U.S. Cl. 307/69

(57) ABSTRACT

A parallel power system provides virtual impedance so that the parallel-connected power supplies can couple each other directly and the parallel-connected power supplies have the same real power output by the adjustment of output voltage references. Furthermore, the virtual impedance is greater than an intrinsic impedance of the power supply and thus the virtual impedance is dominant impedance. Therefore, the parallel-connected power supplies can couple each other directly without linking inductors.

### FIELD OF THE INVENTION

The present invention relates to a parallel power supply system and its control method thereof, and especially to a parallel power supply system with a virtual impedance for directly coupled the power supplies in parallel without linking inductors.

### BACKGROUND OF THE INVENTION

Considering a parallel power supply system, it is necessary for the parallel power supply system to have sufficient output impedances between parallel-connected power supplies so as to make the parallel power supply system operate stably. Nowadays, in the power industry, the different generator can directly couple each other in parallel because there are sufficient impedances in the existing power transmission and distribution network and the parallel-connected generators. Besides, according to the power flow analysis principle, the power distribution problem in the parallel operation of the different generators can be expressed by the following equations:

Pₒᵢ=(VₒᵢVₒ/Xₛ)sin δᵢ (1)

Qₒᵢ=(VₒᵢVₒ cos δᵢ−Vₒ²)/Xₛ (2)

wherein, Pₒᵢ represents the real power output of a generator, Qₒᵢ, represents the reactive power output of a generator, δᵢ represents the power angle of the parallel-connected generators, Xₛ represents the linking inductance, Vₒᵢ represents the output voltage of a generator, and Vₒ represents the output voltage of the parallel-connected generators (i=1, 2, 3 . . . ). From equation (1), when the power angle δᵢ is small enough, the real power output Pₒᵢ is directly proportional to the power angle δᵢ, and the reactive power output Qₒᵢ is directly proportional to the output voltage Vₒᵢ. Thus, the real power output can be controlled by the operation frequency of the generator, and the reactive power output can be controlled by the magnitude of the output voltage. It is a well-known technique applied to the parallel-connected power supplies, and now extensively applied to the power transmission and distribution control of power system.

It is therefore attempted by the applicant to deal with the above situation encountered with the prior art and invent the “PARELLEL POWER SUPPLY SYSTEM AND CONTROL METHOD THEREOF”.

### SUMMARY OF THE INVENTION

It is therefore an object of the present invention to propose a parallel power system and control method thereof to provide a virtual impedance so that the parallel-connected power supplies can couple each other directly without a linking inductor.

It is therefore an object of the present invention to propose a parallel power system and control method thereof to provide a virtual impedance so that the parallel-connected power supplies can couple each other directly without a linking inductor and the parallel-connected power supplies have the same real power output by the adjustment of an output voltage reference.

According to an aspect of the present invention, the control method is provided for being applied to a parallel power supply system in which the parallel power supply system includes at least two power supplies. In the present invention, a virtual impedance is provided by the control method in order to individually increase an output impedance of the power supply so that the power supplies are directly coupled in parallel without any linking inductors. The control method includes steps of detecting an AC output voltage of the parallel power supply system for generating an AC output voltage signal, detecting an AC output current of the parallel power supply system for generating an AC output current signal; transforming the AC output current signal into a first AC voltage signal through the virtual impedance, setting a first AC voltage command signal for controlling a real power output and a reactive power output of the power supply, comparing the first AC voltage command signal with the first AC voltage signal for generating a second AC voltage command signal, and comparing the second AC voltage command signal with the AC output voltage signal for generating a third AC voltage command signal in order to stabilize an output voltage of the power supply.

Preferably, the virtual impedance is greater than an intrinsic impedance of the power supply and the virtual impedance is the dominant impedance.

Preferably, the virtual impedance is a virtual resistance.

Preferably, the real power output is controlled by a magnitude of the first AC voltage command signal and the reactive power output is controlled by a phase of the first AC voltage command signal.

Preferably, the power supplies have the same real power output by individually controlling the first AC voltage command signals of the power supplies.

According to an aspect of the present invention, the parallel power supply system including at least two power supplies for providing a virtual impedance in order to increase an output impedance of the power supply and make the power supplies be directly coupled in parallel. Each of power supply includes a reference voltage generator, a voltage feedback controller, a rectifying and filtering device, a first comparator, a DC voltage compensator, a sinusoidal generator, a multiplier, a current sensor, a virtual impedance generator, a first subtractor, a second subtractor, an AC voltage compensator, a driver circuit, and a switching device. The reference voltage generator provides a DC reference voltage signal. The voltage feedback controller is electrically connected to an output port of the parallel power supply system for feeding back an output voltage of the output port to generate an AC feedback voltage signal. The rectifying and filtering device is electrically connected to the voltage feedback controller for rectifying and filtering the AC feedback voltage signal to generate a DC feedback voltage signal. The first comparator is electrically connected to the reference voltage generator and the rectifying and filtering device for comparing the DC reference voltage signal with the DC feedback voltage signal to generate a first DC voltage command signal. The DC voltage compensator is electrically connected to the first comparator for compensating the first DC voltage command signal to generate a second DC voltage command signal. The sinusoidal generator provides a sinusoidal signal. The multiplier is electrically connected to the DC voltage compensator and the sinusoidal generator for multiplying the second DC voltage command signal with the sinusoidal signal to generate a first AC voltage command signal. The current sensor is electrically to the output port for sensing an AC current command signal. The virtual impedance generator is electrically connected to the current sensor for providing a virtual impedance which is multiplied by the AC current command signal to generate a second AC voltage command signal. The first subtractor is electrically connected to the multiplier and the virtual impedance generator for subtracting the first AC voltage command signal from the second AC voltage command signal to generate a third AC voltage command signal. The second subtractor is electrically connected to the first subtractor and the voltage feedback controller for subtracting the third AC voltage command signal from the AC feedback voltage signal to generate a fourth AC voltage command signal. The AC voltage compensator is electrically connected to the second subtractor for compensating the fourth AC voltage command signal to generate a fifth voltage command signal. The driver circuit is electrically connected to the AC voltage compensator for transforming the fifth voltage command signal into a trigger signal. And, a switching device is electrically connected to the driver circuit and an input power for inverting the input power into an AC output voltage.

Preferably, the virtual impedance is greater than an intrinsic impedance of the power supply and the virtual impedance is a dominant impedance.

Preferably, the virtual impedance is a virtual resistance.

Preferably, the DC reference voltage signal is used for controlling a real power output of the power supplies.

Preferably, the phase of the sinusoidal signal is used for controlling a reactive power output of the power supplies.

Preferably, the power supplies have the same real power output by controlling the DC reference voltage signal.

Preferably, the power supply further comprises an inductor-capacitor filter electrically connected to the switching device for filtering the output voltage.

Preferably, the rectifying and filtering device is a voltage peak calculator.

Preferably, the rectifying and filtering device is a RMS (root-mean-square) calculator.

According to another aspect of the invention, the parallel power supply system includes at least two power supplies for providing a virtual impedance in order to increase an output impedance of the power supply and make the power supplies be directly coupled in parallel without linking inductors.

According to another aspect of the invention, the parallel power supply system including at least two power supplies for providing a virtual impedance in order to increase an output impedance of the power supply and make the power supplies be directly coupled in parallel. Each of power supply includes a reference voltage generator, a voltage feedback controller, a sinusoidal generator, a multiplier, a current sensor, a virtual impedance generator, a first subtractor, a second subtractor, a feedforward controller, an AC voltage command compensator, an adder, an AC current calculator, a third substractor, an AC current compensator, a driver circuit, and a switching device. The reference voltage generator provides a DC reference voltage signal. The voltage feedback controller is electrically connected to an output port of the parallel power supply system for feeding back an output voltage of the output port to generate an AC feedback voltage signal. The sinusoidal generator provides a sinusoidal signal. The multiplier is electrically connected to the reference voltage generator and the sinusoidal generator for multiplying the DC reference voltage signal with the sinusoidal signal to generate a first AC voltage command signal. The current sensor is electrically to the output port for sensing an AC current command signal. The virtual impedance generator is electrically connected to the current sensor for providing a virtual impedance which is multiplied by the AC current command signal to generate a second AC voltage command signal. The first subtractor is electrically connected to the multiplier and the virtual impedance generator for subtracting the first AC voltage command signal from the second AC voltage command signal to generate a third AC voltage command signal. The second subtractor is electrically connected to the first subtractor and the voltage feedback controller for subtracting the third AC voltage command signal from the AC feedback voltage signal to generate a fourth AC voltage command signal. The feedforward controller is electrically connected to the first subtractor for transforming the third AC voltage command signal to a first AC current command signal. The AC voltage command compensator is electrically connected to the second subtractor for compensating the fourth AC voltage command signal to generate a second AC current command signal. The adder is electrically connected to the AC voltage command compensator and the feedforward controller for adding the first AC current command signal and the second AC current command signal together to generate a capacitor current command signal. The AC current calculator is electrically connected to the voltage feedback controller for transforming the AC feedback voltage signal to a capacitor current signal. The third substractor is electrically connected to the adder and the AC current calculator for subtracting the capacitor current command signal from the capacitor current signal to generate a third AC current command signal. The AC current compensator is electrically connected to the third subtractor for compensating the third AC current command signal to generate a fourth AC current command signal. The driver circuit is electrically connected to the AC current compensator for transforming the fourth AC current command signal into a trigger signal. And, the switching device is electrically connected to the driver circuit and an input power for inverting the input power into an AC output voltage.

The present invention may best be understood through the following description with reference to the accompanying drawings, in which:

### BRIEF DESCRIPTION OF THE DRAWINGS

FIGS. 1(a)˜(b) illustrate a parallel power supply system with a virtual resistance characteristic according to a preferred embodiment of the present invention;

FIGS. 2(a)˜(b) illustrate P-V (Real Power-Voltage) droop characteristics and Q-f (Reactive Power-Frequency) droop characteristics according to a preferred embodiment of the present invention;

FIG. 3 is a schematic diagram illustrating a parallel power supply system with a virtual resistance characteristic according to a first preferred embodiment of the present invention; and

FIG. 4 is a schematic diagram illustrating a parallel power supply system with a virtual resistance characteristic according to a second preferred embodiment of the present invention.

### DETAILED DESCRIPTION OF THE PREFERRED EMBODIMENT

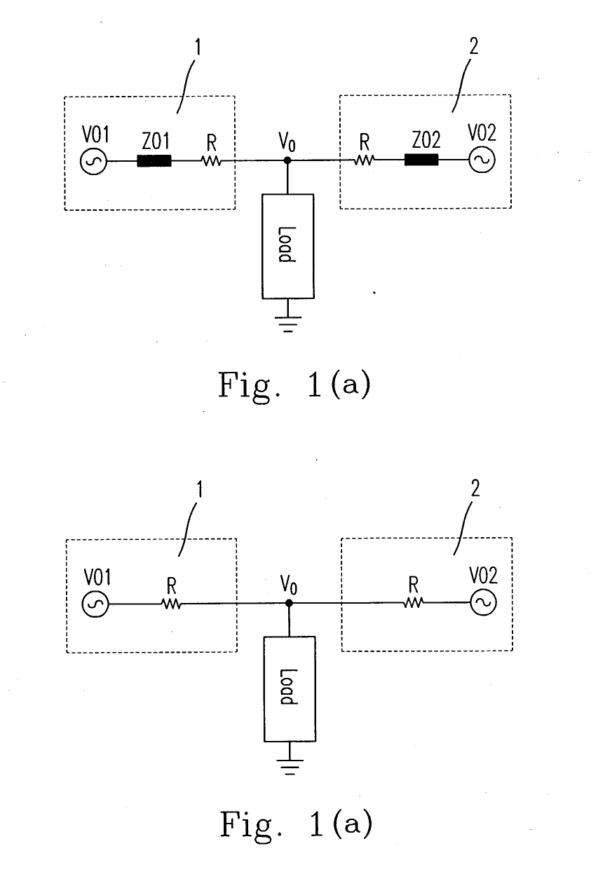

FIGS. 1(a)˜(b) illustrate a parallel power supply system with a virtual resistance characteristic according to a preferred embodiment of the present invention. As shown in FIG. 1, a first power supply 1 has a first voltage source V01 electrically connected to a first output impedance Z01, and a second power supply 2 has a second voltage source V02 electrically connected to a second output impedance Z02. The power supplies 1, 2 are individually connected to a resistor and then electrically connected to a load.

However, the resistor is a virtual resistor R. The virtual resistor R is simulated by the resistive voltage droop characteristic of the power supplies 1, 2. Thus, the power supplies 1, 2 can be directly connected to each other without a linking inductor. When the virtual resistance is greater than the output impedances Z01, Z02, the equivalent circuit of FIG. 1(a) is shown in FIG. 1(b). The equations can be derived from the basic electrical circuit principle as follows:

Pₒᵢ=(VₒᵢVₒ cos δᵢ−Vₒ²)/R (3)

Qₒᵢ=(VₒᵢVₒ/R)sin δᵢ (4)

wherein, Pₒᵢ represents the real power output of a generator, Qₒᵢ represents the reactive power output of a generator, δᵢ represents the power angle of the parallel-connected generators, Xₛ represents the linking inductance, Vₒᵢ represents the output voltage of a generator, and Vₒ represents the output voltage of the parallel-connected generators (i=1, 2, 3 . . . ). From equation (3), when the power angle δᵢ is small enough, the real power output Pₒᵢ is directly proportional to the output voltage Vₒᵢ, and the reactive power output Qₒᵢ is directly proportional to the power angle δᵢ. Thus, the real power output can be controlled by the magnitude of the output voltage, and the reactive power output can be controlled by the operation frequency of each power supply.

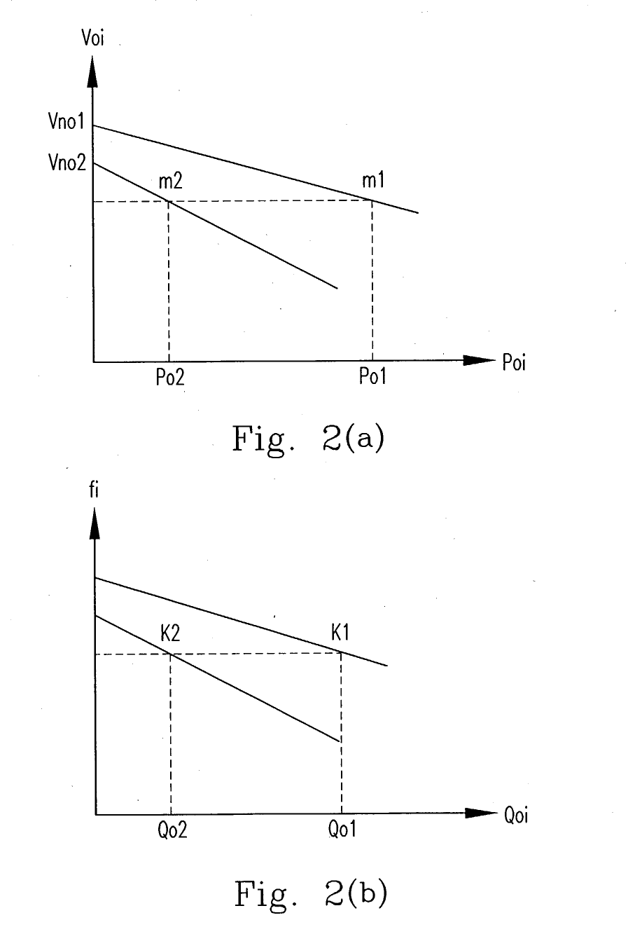

Please refer to FIG. 2 (a)˜(b), which illustrate a P-V (Real Power-Voltage) droop characteristics and a Q-f (Reactive Power-Frequency) according to a preferred embodiment of the present invention. As shown in FIG. 2(a), it is a schematic diagram illustrating P-V (Real Power-Voltage) droop characteristics. The output voltage of the ith power supply is Vₒᵢ=Vₙₒᵢ−mᵢPₒᵢ, wherein Vₙₒᵢ represents the voltage magnitude of the ith power supply with no load, mᵢ represents the droop coefficient. The magnitude of mᵢ is determined by the virtual resistance. Thus, the real power output Vₙₒᵢ can be controlled by the output voltage of a power supply.

In addition, if the output voltage V01 almost equals to the output voltage V02 (V₀₁≈V₀₂), it can be derived from equation (4) as follows:

Qᵢ=kδᵢ, k=VₒᵢVₒ/R(i=1,2)

Please refer to FIG. 2(b), which illustrates a Q-f (Reactive Power-Frequency) droop characteristic according to a preferred embodiment of the present invention. Thus, the reactive power output Qₒᵢ can be controlled by the operation frequency fi of a power supply.

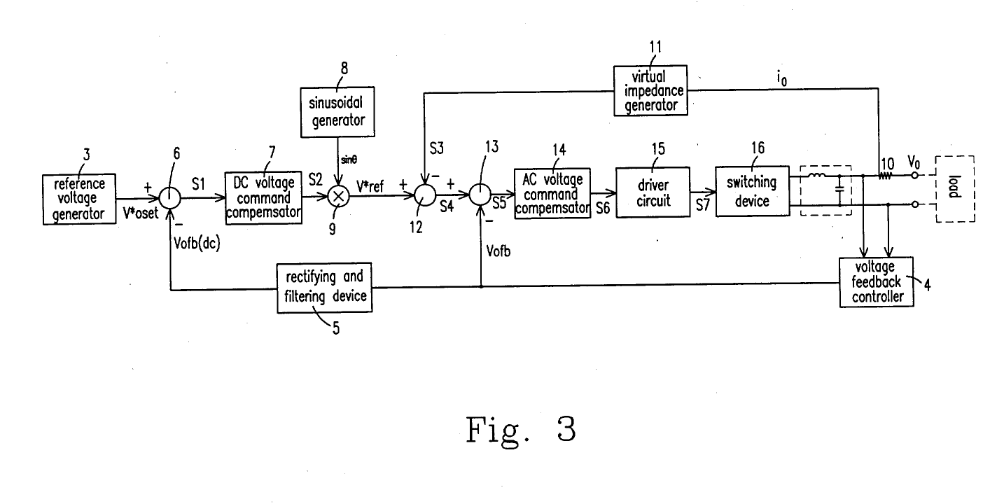

Please refer to FIG. 3, which is a schematic diagram illustrating a parallel power supply system with a virtual resistance characteristic according to a first preferred embodiment of the present invention.

Each of power supply includes a reference voltage generator 3, a voltage feedback controller 4, a rectifying and filtering device 5, a first comparator 6, a DC voltage compensator 7, a sinusoidal generator 8, a multiplier 9, a current sensor 10, a virtual impedance generator 11, a first subtractor 12, a second subtractor 13, an AC voltage compensator 14, a driver circuit 15, and a switching device 16. The reference voltage generator 3 provides a DC reference voltage signal V*ₒₛₑₜ. The voltage feedback controller 4 is electrically connected to an output port of the parallel power supply system for feeding back an output voltage of the output port to generate an AC feedback voltage signal V_{ofb}. The rectifying and filtering device 5 is electrically connected to the voltage feedback controller 4 for rectifying and filtering the AC feedback voltage signal V_{ofb} to generate a DC feedback voltage signal V_{ofb(dc)}. The first comparator 6 is electrically connected to the reference voltage generator 3 and the rectifying and filtering device 5 for comparing the DC reference voltage signal V*ₒₛₑₜ with the DC feedback voltage signal V_{ofb(dc)} to generate a first DC voltage command signal S₁. The DC voltage compensator 7 is electrically connected to the first comparator 6 for compensating the first DC voltage command signal S₁ to generate a second DC voltage command signal S₂. The sinusoidal generator 8 provides a sinusoidal signal sin θ. The multiplier 9 is electrically connected to the DC voltage compensator 7 and the sinusoidal generator 8 for multiplying the second DC voltage command signal S₂ with the sinusoidal signal sin θ to generate a first AC voltage command signal V*_{ref}. The current sensor 10 is electrically to the output port for sensing an AC current command signal iₒ. The virtual impedance generator 11 is electrically connected to the current sensor 10 for providing a virtual impedance which is multiplied by the AC current command signal iₒ to generate a second AC voltage command signal S₃. The first subtractor 12 is electrically connected to the multiplier 9 and the virtual impedance generator 11 for subtracting the first AC voltage command signal V*_{ref} from the second AC voltage command signal S₃ to generate a third AC voltage command signal S₄. The second subtractor 13 is electrically connected to the first subtractor 12 and the voltage feedback controller 4 for subtracting the third AC voltage command signal S₄ from the AC feedback voltage signal V_{ofb} to generate a fourth AC voltage command signal S₅. The AC voltage compensator 14 is electrically connected to the second subtractor 13 for compensating the fourth AC voltage command signal S₅ to generate a fifth voltage command signal S₆. The driver circuit 15 is electrically connected to the AC voltage compensator 14 for transforming the fifth voltage command signal S₆ into a trigger signal S₇. And, a switching device 16 is electrically connected to the driver circuit 15 and an input power for inverting the input power into an AC output voltage Vₒ. The power supply further includes an inductor-capacitor filter for filtering the AC output voltage Vₒ.

However, the rectifying and filtering device can be a peak value calculator or a root-mean-square calculator.

The adjustment of the DC reference voltage signal V*ₒₛₑₜ can control the real power output of the power supply to make the power supplies have the same real power output. At the same time, the adjustment of the phase of the sinusoidal wave can control the reactive power output of the power supply.

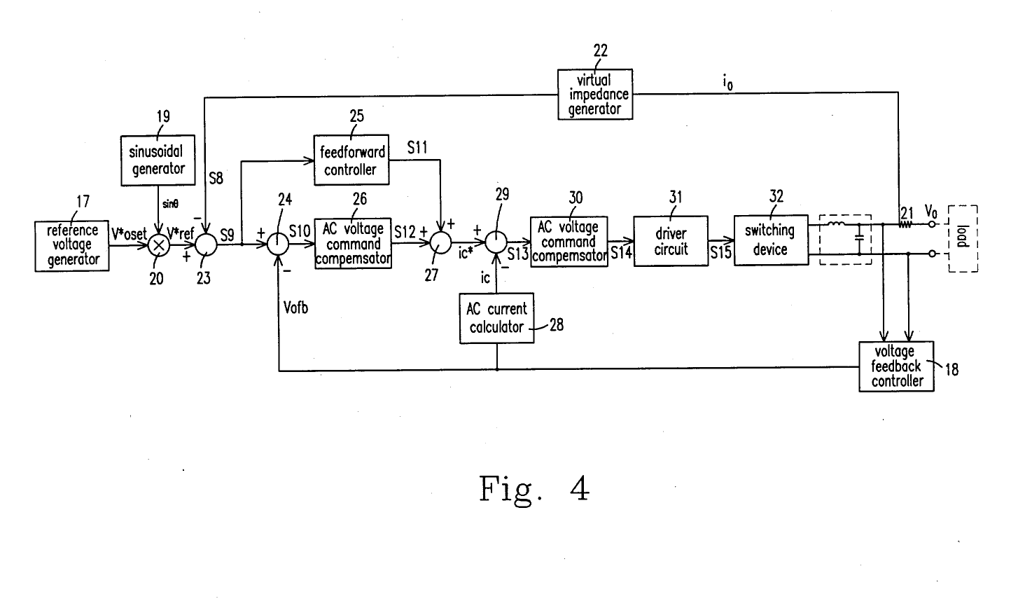

Please refer to FIG. 4, which is a schematic diagram illustrating a parallel power supply system with a virtual resistance characteristic according to a second preferred embodiment of the present invention.

Each of power supply includes a reference voltage generator 17, a voltage feedback controller 18, a sinusoidal generator 19, a multiplier 20, a current sensor 21, a virtual impedance generator 22, a first subtractor 23, a second subtractor 24, a feedforward controller 25, an AC voltage command compensator 26, an adder 27, an AC current calculator 28, a third substractor 29, an AC current compensator 30, a driver circuit 31, and a switching device 32. The reference voltage generator 17 provides a DC reference voltage signal V*ₒₛₑₜ. The voltage feedback controller 18 is electrically connected to an output port of the parallel power supply system for feeding back an output voltage of the output port to generate an AC feedback voltage signal V_{ofb}. The sinusoidal generator 19 provides a sinusoidal signal sin θ. The multiplier 20 is electrically connected to the reference voltage generator 17 and the sinusoidal generator 19 for multiplying the DC reference voltage signal V*ₒₛₑₜ with the sinusoidal signal sin θ to generate a first AC voltage command signal V*_{ref}. The current sensor 21 is electrically to the output port for sensing an AC current command signal iₒ. The virtual impedance generator 22 is electrically connected to the current sensor 21 for providing a virtual impedance which is multiplied by the AC current command signal iₒ to generate a second AC voltage command signal S₈. The first subtractor 23 is electrically connected to the multiplier 20 and the virtual impedance generator 22 for subtracting the first AC voltage command signal V*_{ref} from the second AC voltage command signal S₈ to generate a third AC voltage command signal S₉. The second subtractor 24 is electrically connected to the first subtractor 23 and the voltage feedback controller 18 for subtracting the third AC voltage command signal S₉ from the AC feedback voltage signal V_{ofb} to generate a fourth AC voltage command signal S₁₀. The feedforward controller 25 is electrically connected to the first subtractor 23 for transforming the third AC voltage command signal S₉ to a first AC current command signal S₁₁. The AC voltage command compensator 26 is electrically connected to the second subtractor 24 for compensating the fourth AC voltage command signal S₁₀ to generate a second AC current command signal S₁₂. The adder 27 is electrically connected to the AC voltage command compensator 26 and the feedforward controller 25 for adding the first AC current command signal S₁₁ and the second AC current command signal S₁₂ together to generate a capacitor current command signal i_{c}*. The AC current calculator 28 is electrically connected to the voltage feedback controller 18 for transforming the AC feedback voltage signal V_{ofb} to a capacitor current signal i_{c}. The third substractor 29 is electrically connected to the adder 27 and the AC current calculator 28 for subtracting the capacitor current command signal i_{c}* from the capacitor current signal i_{c} to generate a third AC current command signal S₁₃. The AC current compensator 30 is electrically connected to the third subtractor 29 for compensating the third AC current command signal S₁₃ to generate a fourth AC current command signal S₁₄. The driver circuit 31 is electrically connected to the AC current compensator 30 for transforming the fourth AC current command signal S₁₄ into a trigger signal S₁₅. And, the switching device 32 is electrically connected to the driver circuit 31 and an input power for inverting the input power into an AC output voltage.

Owing to the above descriptions, the parallel power supply system with virtual resistors and its control method are provided by the invention. The invention mainly is applied to the parallel operation of the UPS. Owing to the virtual resistor characteristics, the parallel operation of the UPS system does not need a linking inductor. Therefore, the present invention can solve the drawbacks of the parallel-connected UPS system encountered with the prior art

While the invention has been described in terms of what are presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method for being applied to a parallel power supply system in which said parallel power supply system includes at least two power supplies and a virtual impedance is provided by said control method in order to individually increase an output impedance of said power supply so that said power supplies are directly coupled in parallel, comprising steps of:
detecting an AC output voltage of said parallel power supply system for generating an AC output voltage signal;
detecting an AC output current of said parallel power supply system for generating an AC output current signal;
transforming said AC output current signal into a first AC voltage signal through said virtual impedance;
setting a first AC voltage command signal for controlling a real power output and a reactive power output of said power supply;
comparing said first AC voltage command signal with said first AC voltage signal for generating a second AC voltage command signal; and
comparing said second AC voltage command signal with said AC output voltage signal for generating a third AC voltage command signal in order to stabilize an output voltage of said power supply.

2. The control method according to claim 1, wherein a value of said virtual impedance is greater than an intrinsic impedance of said power supply and said virtual impedance is a dominant impedance.

3. The control method according to claim 2, wherein said virtual impedance is a virtual resistance.

4. The control method according to claim 3, wherein said real power output is controlled by a magnitude of said first AC voltage command signal and said reactive power output is controlled by a phase of said first AC voltage command signal.

5. The control method according to claim 4, wherein said power supplies have the same real power output by individually controlling said first AC voltage command signals of said power supplies.

6. A parallel power supply system comprising at least two power supplies for providing a virtual impedance in order to increase an output impedance of said power supply and make said power supplies be directly coupled in parallel, each of power supply comprising:
a reference voltage generator for providing a DC reference voltage signal;
a voltage feedback controller electrically connected to an output port of said parallel power supply system for feeding back an output voltage of said output port to generate an AC feedback voltage signal;
a rectifying and filtering device electrically connected to said voltage feedback controller for rectifying and filtering said AC feedback voltage signal to generate a DC feedback voltage signal;
a first comparator electrically connected to said reference voltage generator and said rectifying and filtering device for comparing said DC reference voltage signal with said DC feedback voltage signal to generate a first DC voltage command signal;
a DC voltage compensator electrically connected to said first comparator for compensating said first DC voltage command signal to generate a second DC voltage command signal;
a sinusoidal generator for providing a sinusoidal signal;
a multiplier electrically connected to said DC voltage compensator and said sinusoidal generator for multiplying said second DC voltage command signal with said sinusoidal signal to generate a first AC voltage command signal;
a current sensor electrically to said output port for sensing an AC current command signal;
a virtual impedance generator electrically connected to said current sensor for providing a virtual impedance which is multiplied by said AC current command signal to generate a second AC voltage command signal;
a first subtractor electrically connected to said multiplier and said virtual impedance generator for subtracting said first AC voltage command signal from said second AC voltage command signal to generate a third AC voltage command signal;
a second subtractor electrically connected to said first subtractor and said voltage feedback controller for subtracting said third AC voltage command signal from said AC feedback voltage signal to generate a fourth AC voltage command signal;
an AC voltage compensator electrically connected to said second subtractor for compensating said fourth AC voltage command signal to generate a fifth voltage command signal;
a driver circuit electrically connected to said AC voltage compensator for transforming said fifth voltage command signal into a trigger signal; and
a switching device electrically connected to said driver circuit and an input power for inverting said input power into an AC output voltage.

7. The parallel power supply system according to claim 6, wherein said virtual impedance is greater than an intrinsic impedance of said power supply and said virtual impedance is a dominant impedance.

8. The parallel power supply system according to claim 7, wherein said virtual impedance is a virtual resistance.

9. The parallel power supply system according to claim 8, wherein said DC reference voltage signal is used for controlling a real power output of said power supplies.

10. The parallel power supply system according to claim 8, wherein said a phase of said sinusoidal signal is used for controlling a reactive power output of said power supplies.

11. The parallel power supply system according to claim 9, wherein said power supplies have the same real power output by controlling said DC reference voltage signal.

12. The parallel power supply system according to claim 6, wherein said power supply further comprises an inductor-capacitor filter electrically connected to said switching device for filtering said output voltage.

13. The parallel power supply system according to claim 6, wherein said rectifying and filtering device is a voltage peak calculator.

14. The parallel power supply system according to claim 6, wherein said rectifying and filtering device is a RMS (root-mean-square) calculator.

15. A parallel power supply system comprising at least two power supplies for providing a virtual impedance in order to increase an output impedance of said power supply and make said power supplies be directly coupled in parallel without linking inductors.

16. A parallel power supply system comprising at least two power supplies for providing a virtual impedance in order to increase an output impedance of said power supply and make said power supplies be directly coupled in parallel, each of power, supply comprising:
a reference voltage generator for providing a DC reference voltage signal;
a voltage feedback controller electrically connected to an output port of said parallel power supply system for feeding back an output voltage of said output port to generate an AC feedback voltage signal;
a sinusoidal generator for providing a sinusoidal signal;
a multiplier electrically connected to said reference voltage generator and said sinusoidal generator for multiplying said DC reference voltage signal with said sinusoidal signal to generate a first AC voltage command signal;
a current sensor electrically to said output port for sensing an AC current command signal;
a virtual impedance generator electrically connected to said current sensor for providing a virtual impedance which is multiplied by said AC current command signal to generate a second AC voltage command signal;
a first subtractor electrically connected to said multiplier and said virtual impedance generator for subtracting said first AC voltage command signal from said second AC voltage command signal to generate a third AC voltage command signal;
a second subtractor electrically connected to said first subtractor and said voltage feedback controller for subtracting said third AC voltage command signal from said AC feedback voltage signal to generate a fourth AC voltage command signal;
a feedforward controller electrically connected to said first subtractor for transforming said third AC voltage command signal to a first AC current command signal;
an AC voltage command compensator electrically connected to said second subtractor for compensating said fourth AC voltage command signal to generate a second AC current command signal;
an adder electrically connected to said AC voltage command compensator and said feedforward controller for adding said first AC current command signal and said second AC current command signal together to generate a capacitor current command signal;
an AC current calculator electrically connected to said voltage feedback controller for transforming said AC feedback voltage signal to a capacitor current signal;
a third substractor electrically connected to said adder and said AC current calculator for subtracting said capacitor current command signal from said capacitor current signal to generate a third AC current command signal;
an AC current compensator electrically connected to said third subtractor for compensating said third AC current command signal to generate a fourth AC current command signal;
a driver circuit electrically connected to said AC current compensator for transforming said fourth AC current command signal into a trigger signal; and
a switching device electrically connected to said driver circuit and an input power for inverting said input power into an AC output voltage.
